(19) United States
(12) Patent Application Publication
(10) Pub. No.: US 2004/0182249 A1
(43) Pub. Date: Sep. 23, 2004

(54) Filter basket

(76) Inventor: John Wilson, Felton, CA (US)

Correspondence Address: John Wilson, 3 Kelldon Drive, Felton, CA, 95018, US

(21) Appl. No.: 10/392,253

(22) Filed: Mar. 20, 2003

(51) Int. Cl. A47J 31/00

(52) U.S. Cl. 99/279

(57) ABSTRACT

The present invention achieves its purposes by providing, in a preferred embodiment, a coffee-maker filter basket that has:

1. A benefit for the user because it can be cleaned entirely, thoroughly, easily, quickly, and without the use of a harmful chemical.

2. A marketing advantage because it is commercially advantageous to make the filter basket of white, light-colored, or transparent material.

3. A displaceable partition which can be moved to provide easy access to all areas of the filter basket for cleaning.

4. Flared apertures.

5. Rounding of interior corners, exterior corners, and other angularities, that are exposed to coffee infusion.

6. Wide infusion-draining apertures.

7. A minimum of infusion-draining apertures.

8. A strainer that is made of high wet-strength porous paper that has a long-fiber content.

### CROSS REFERENCE TO RELATED PUBLICATIONS

Not Applicable

### BACKGROUND OF THE INVENTION

1. Field of Invention

This invention relates to devices employed in the preparation of consumable liquid infusions.

2. Prior Art

A widely used, refreshing, and stimulating beverage is an infusion of the beans of the coffee plant, Coffea arabica. The beverage is prepared by a brewing process in which roasted, granulated beans of the plant are exposed to water that is at or near a temperature of 212° Fahrenheit.

Typically, the beverage is brewed in a device known as a coffee maker. A widely used type of coffee maker employs a receptacle called a filter basket. To prepare the beverage, a quantity of roasted and granulated coffee beans is placed in the filter basket. Hot water is then introduced to the filter basket. The hot water flows past the granulated coffee beans and extracts therefrom a flavorful essence.

The resulting infusion flows through one or more apertures in the filter basket and falls into a receptacle.

In some types of coffee maker the infusion passes through a porous strainer before leaving the filter basket.

As brewing is taking place the infusion deposits a film, fine particles, or other residuum on surfaces of the filter basket contacted by the infusion. The deposit is unsightly. It also accumulates with subsequent use of the filter basket and contaminates infusions with byproducts that impart an undesirable flavor to the beverage.

In filter baskets made in accordance with prior art, it is difficult to remove all of the aforesaid deposit by manual cleaning. The person carrying out the cleaning will usually be aware of this shortcoming and will dislike the difficulty of achieving cleanliness.

The problem of manually cleaning a prior-art filter basket arises from the following causes:

1. The filter basket has interior corners and crevices that are difficult or impossible to reach fully into with a cleaning pad or cleaning brush.

2. Because of the narrowness of the filter basket it is difficult to exert sufficient hand pressure on the bottom of the filter basket to effectuate adequate cleaning

3. The filter basket may have small apertures for egress of the infusion. The walls of the apertures are impossible to reach with a cleaning pad or brush and therefore cannot be manually cleaned unless unusual measures are taken.

4. Filter baskets are often made of a dark material. This makes the aforesaid deposit difficult or impossible to discern because the deposit itself has a dark coloration. As a result, the deposit may be overlooked even when it can be easily reached. Consequently it may not be cleaned off.

As an alternative to manual cleaning, a chemical capable of removing the aforesaid deposit may be used. Dilute sulfamic acid has been employed for this purpose. However, the dilute sulfamic acid sold for this use is harmful if it contacts the skin or eyes or if it is ingested. It must also be kept out of reach of children.

As well as being harmful if misused, chemical cleaning has other disadvantages:

1. The chemical must be used frequently to ensure continued cleanliness.

2. After each use of the chemical a second cleaning or a thorough rinsing is needed to remove the chemical.

3. Failure to completely remove the chemical will result in chemical contamination of the next batch of coffee brewed.

4. The cost of the chemical is undesirable.

Disposable filter baskets have been designed. These are intended for one-time use after which they are discarded. This avoids entirely the cleaning problem. However, this type of filter basket is relatively expensive to use because the entire filter basket is discarded after a single use.

In view of these difficulties, there is a need for a permanent filter basket that can be cleaned entirely, thoroughly, easily, quickly, and without harmful chemicals. The present invention is designed to fill these needs.

3. Objects and Advantages

An object and advantage of the present invention is to provide a filter basket that can be cleaned entirely, thoroughly, easily, quickly, and without the use of harmful chemicals.

Another object and advantage is to make it commercially advantageous to market a coffee maker that has a filter basket made of white, light-colored, or transparent material. In prior-art filter baskets, a light coloration or transparency reveals areas that need cleaning. However, some of these areas cannot easily be reached and may be left as highly visible unclean areas. As a result, the user may avoid future purchase of items that bear the brand name concerned. In prior-art filter baskets that have a dark coloration, the unwashed areas are not highly visible but the user is often aware that they are present and is dissatisfied with the lack of cleanliness. In contrast, in the present invention a white or light coloration, or transparency, is commercially advantageous because all unclean areas of the filter basket are clearly revealed and can also be easily reached for cleaning. The user will be pleased with the cleanliness that can be achieved and will have a favorable impression of the brand name.

Another object and advantage of the invention is to provide an improved filter basket that can be manufactured at low cost.

Another object and advantage is to provide an improved filter basket that can be manufactured with the same techniques and machinery employed in the manufacture of prior-art filter baskets.

Further objects and advantages will become apparent from a consideration of the ensuing description and drawings.

### SUMMARY

The present invention achieves its purposes by providing a filter basket that has:

1. Flaring of apertures which are contacted by the infusion. The flaring may be as follows:

(a) The flare is preferably funnel shaped (with straight sides).

(b) The flare can be trumpet shaped or bowl shaped (with curved sides).

(c) Preferably, the flare extends through the entire thickness of the material penetrated by the aperture. The aperture therefore has no parallel walls.

(d) There may be a separate flare at each outer opening of an aperture. Preferably, the two flares meet each other, with the aperture therefore having no parallel walls.

2. A displaceable partition which can be moved to provide full and easy access for cleaning to all parts of the filter basket.

3. Rounding of interior corners, exterior corners, and other angularities. This facilitates cleaning.

4. Apertures in the form of parallel slots for egress of the infusion. Except when restricted in length by the boundaries of the surrounding area, parallel slots can be longer than radial slots. With longer slots, and for a given total area of slot opening, there are fewer slots to clean.

5. Straight slots for egress of the infusion. This expedites cleaning.

6. For egress of the infusion, the minimum number of apertures consistent with sufficiently fast draining of the filter basket. This leaves fewer aperture walls to clean.

7. A strainer composed of porous paper that has a long-fiber content and a high wet strength. This allows wide infusion-draining apertures, resulting in fewer apertures for a given infusion flow rate. As a result, there are fewer aperture walls to clean.

### DRAWINGS—FIGS. 1 THROUGH 16

FIGS. 1 through 16 depict filter baskets made in accordance with the present invention. FIGS. 1 through 10 show a preferred embodiment. FIGS. 11 through 16 show the pertinent parts of alternative embodiments. The illustrations portray aspects and components of the invention as follows:

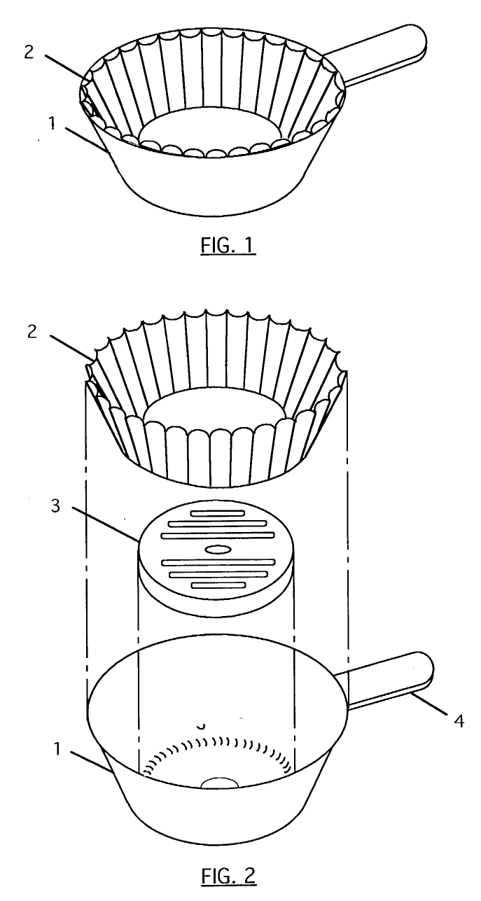

1. FIG. 1 is an overall view of the improved filter basket.

2. FIG. 2 illustrates a displaceable partition and a strainer separated from the main body of the filter basket.

3. FIG. 3 is a top view of the filter basket with the strainer removed.

4. FIG. 4 is a top view of the displaceable partition.

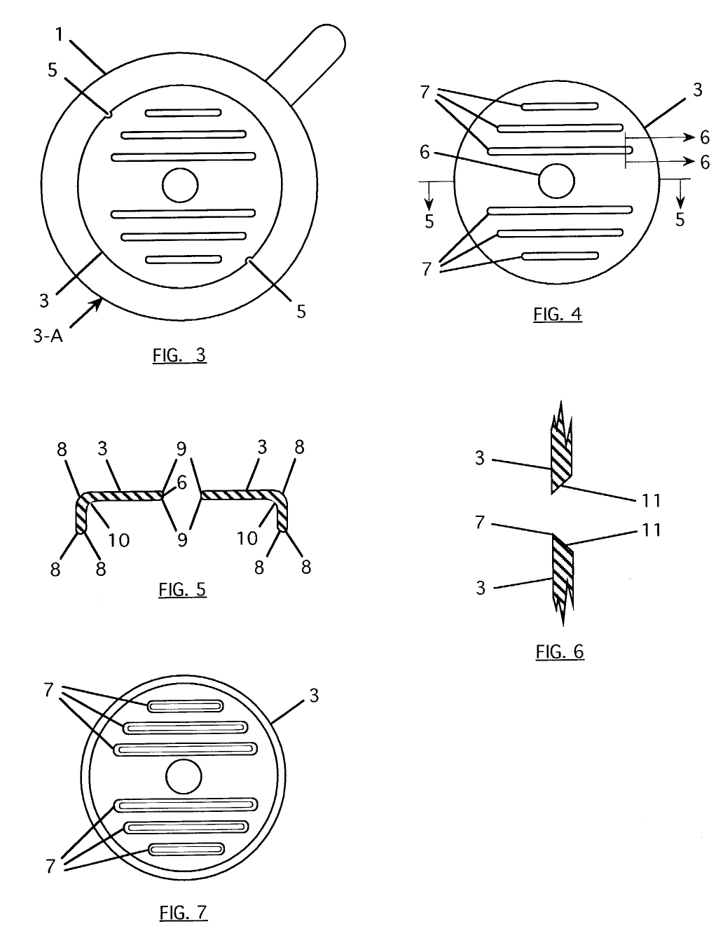

5. FIG. 5 is a transverse section of the displaceable partition. The sectionalizing cleavage is indicated in FIG. 4.

6. FIG. 6 is a transverse section across one of the parallel slots in the displaceable partition. The sectionalizing cleavage is indicated in FIG. 4.

7. FIG. 7 shows the underside of the displaceable partition.

8. FIG. 8 is a top view of the filter basket with the strainer and displacement partition removed.

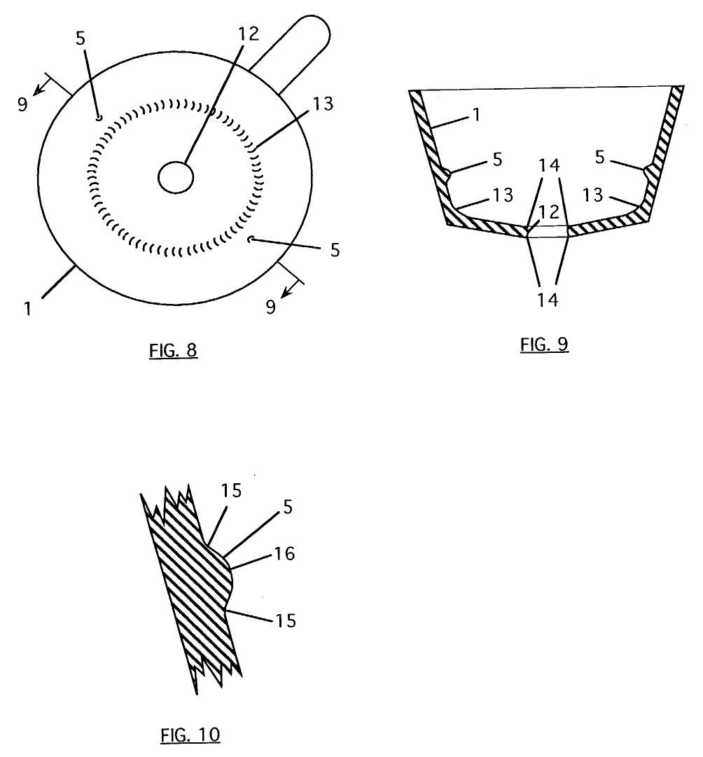

9. FIG. 9 shows a transverse section of the main body. The sectionalizing cleavage is indicated in FIG. 8.

10. FIG. 10 is an enlarged view of the left-hand retaining stud (5) in FIG. 9.

11. FIG. 11 is a top view of the displaceable partition used in the first alternative embodiment of the invention.

12. FIG. 12 is a cross section of part of the displaceable partition used in the first alternative embodiment. The sectionalizing cleavage is indicated in FIG. 11.

13. FIG. 13 is a top view of the displaceable partition used in the second alternative embodiment of the invention.

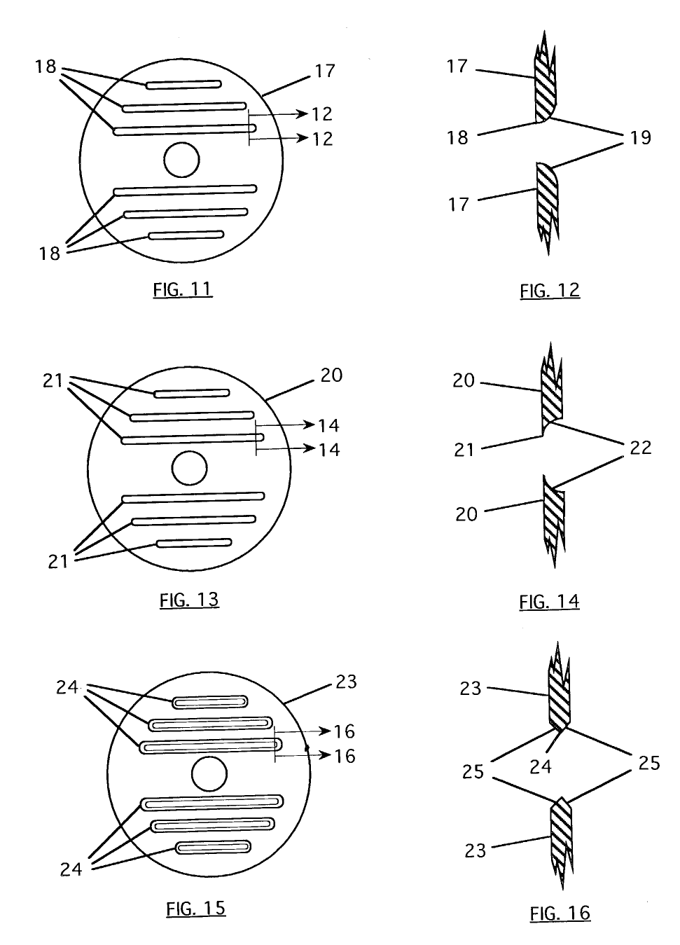

14. FIG. 14 is a cross section of part of the displaceable partition used in the second alternative embodiment. The sectionalizing cleavage is indicated in FIG. 13.

15. FIG. 15 is a top view of the displaceable partition used in the third alternative embodment of the invention.

16. FIG. 16 is a cross section of part of the displaceable partition used in the third alternative embodiment. The seciontalizing cleavage is indicated in FIG. 15.

### DRAWINGS—REFERENCE NUMERALS

The numerals listed below identify in the Figs the various parts and features of the invention. Like numerals represent the same element throughout the FIGS.

1. Main body

2. Strainer

3. Displaceable partition embodiment

3-A. Strainer holder, comprised of main body 1 and displaceable partition 3.

4. Handle

5. Retaining stud

6. Drain hole in displaceable partition 3

7. Parallel slots in displaceable partition 3

8. Rounded upper and bottom corners of displaceable partition 3

9. Rounded corners of material surrounding drain hole 6

10. Rounded interior corner of displaceable partition 3

11. Flared wall of parallel slots 7

12. Drain hole in main body 1

13. Rounded interior corner of main body 1

14. Rounded corners of material around drain hole 12

15. Rounded base corner of retaining studs 5

16. Rounded apex of retaining studs 5

17. Displaceable partition used in the first alternative embodiment

18. Parallel slots used in the first alternative embodiment

19. Trumpet shaped flare used in the first alternative embodiment

20. Displaceable partition used in the second alternative embodiment

21. Parallel slots used in the second alternative embodiment

22. Bowl shaped flare used in the second alternative embodiment

23. Displaceable partitin used in the third alternative embodiment

24. Parallel slots used in the third alternative embodment

25. Double-ended funnel shaped flare used in the third alternative embodiment

### DETAILED DESCRIPTION—PREFERRED EMBODIMENT—FIGS. 1 THROUGH 10

The preferred embodiment of the improved filter basket is comprised of three parts: main body 1, strainer 2, and displaceable partition 3. These are shown in FIGS. 1 and 2.

Handle 4 is an integral part of the main body. It enables the filter basket to be held or carried.

The main body and the displaceable partition are made of white plastic which is capable of withstanding boiling water without deformation or discoloration. The main body is slightly flexible. A person with ordinary familiarity in the prior art will be able to specify a suitable plastic for these components.

Strainer 2 is made of filter paper. It is capable of withstanding boiling water without damage to its filtering effectiveness. To resist tearing, the paper has high wet-strength and a long-fiber content. It also has a color-fast yellow hue to distinguish it from other types of strainer used in filter baskets. A person with ordinary familiarity in the prior art will be able to specify a suitable paper.

The strainer is pleated to form a shallow cup which fits into the main body, as shown in FIGS. 1 and 2. The strainer is intended to be discarded after a single use.

FIG. 3 is a top view of the main body with the strainer removed and the displaceable partition in place. Retaining studs 5 retain the displaceable partition, which snaps past the studs when the filter basket is assembled.

FIG. 4 is a top view of the displaceable partition. The Fig shows a drain hole, 6, and a plurality of parallel slots, 7. These apertures allow egress of the infusion. Drain hole 6 is of a diameter sufficient to allow insertion of a human finger draped with a cleaning cloth.

FIG. 5 is a cross-sectional view of the displaceable partition. Upper and bottom corners 8 of the displaceable partition are rounded about the entire periphery of the displaceable partition. Upper and lower corners 9 of the material around drain hole 6 are rounded about the entire periphery of the drain hole. Interior corner 10 is rounded around the entire displaceable partition.

FIG. 6 is a transverse section across one of parallel slots 7. Wall 11 of the slot is flared in a funnel shape. The flaring extends entirely through the material of the displaceable partition, leaving no parallel walls to the slot. The flaring extends for the entire periphery of the slot, including the ends of the slot. All parallel slots 7 are so flared.

FIG. 7 is an underside view of the displaceable partition, showing the flaring of parallel slots 7.

FIG. 8 is a top view of the main body. The Fig shows a drain hole, 12, in the main body. Drain hole 12 permits the infusion to drain from the filter basket. Drain hole 12 is of a diameter sufficient to allow insertion of a human finger draped with a cleaning cloth. Interior corner 13 is rounded entirely around the main body. Retaining studs 5 hold the displaceable partition in place.

FIG. 9 is a sectional view of main body 1. The Fig shows that the bottom of the main body has an inwardly-directed downward slope. This slope extends entirely around the main body. The slope directs the infusion toward drain hole 12. Top and bottom exterior corners 14 of drain hole 12 are rounded. This rounding extends about the entire drain hole. The main body has two identical, mammilla shaped, retaining studs (5, FIGS. 8, 9 and 10). Base corners 15 of both retaining studs are rounded about the entire periphery of the stud. Apexes 16 of both retaining studs are rounded about the entire stud.

### DETAILED DESCRIPTION—OPERATION—PREFERRED EMBODIMENT

Preparatory steps for brewing a coffee infusion with the preferred embodiment are as follows. First, the displaceable partition is placed in the main body with the narrow openings of the parallel slots uppermost (FIGS. 3 and 6).

The displaceable partition is manually pressed into place, causing it to snap past retaining studs 5 (FIG. 3). The distance between the apexes of the retaining studs is slightly less than the diameter of the displaceable partition. Main body 1 is of such material as to be somewhat flexible, and momentary flexure of the main body allows the displaceable partition to pass the retaining studs. The rounded apexes of the retaining studs assist this passage. The rounded outer bottom corner of the displaceable partition (FIG. 5) also assists passage.

When the displaceable partition passes the retaining studs, a snapping sound assures the user that the displaceable partition is fully in place. The snapping sound also gives a satisfying sense of accomplishment.

When in place, the displaceable partition is held between the retaining studs and the bottom of the main body. The retaining studs are so positioned vertically on the main body that the displaceable partition is held without looseness.

When the main body and displaceable partition are assembled together they constitute a strainer holder (3-A, FIG. 3).

Next a strainer is installed in the strainer holder (FIGS. 1 and 2).

Upon completion of the preparatory steps described above, the infusion is brewed in the following manner:

1. A measured quantity of granulated coffee beans is placed in the strainer.

2. Handle 4 is used to install the filter basket above a receptacle for the infusion. A support to hold the filter basket in position during brewing can be designed by a person with ordinary familiarity in the prior art.

3. Taking into consideration the quantity of granulated coffee beans used, hot water of an amount that will produce a tasty infusion is introduced to the filter basket. The water can either be poured in by hand from a container or it can be introduced automatically. A person with ordinary familiarity in the prior art can design a method for the automatic addition of the appropriate amount of hot water.

4. The hot water extracts infusion products from the granulated coffee beans.

5. Under the influence of gravity, the infusion passes through strainer 2 and from thence through drain hole 6 and parallel slots 7 in the displaceable partition (FIG. 4). The flow rate of the infusion is determined by the total area of the narrow openings of the parallel slots, by the diameter of drain hole 6, and by the porosity of the strainer. The flow rate must be slow enough to allow adequate extraction of desirable infusion products, but rapid enough to prevent extraction of undesirable byproducts. Also, the flow rate must not be so rapid as to cause overflow of the filter basket.

6. After passing through the displaceable partition, the infusion falls to the bottom of the main body and from thence flows through drain hole 12 (FIG. 9).

7. The receptacle beneath the filter basket receives the infusion.

8. When the brewing process is complete, a quantity of the coffee-bean infusion may be poured into a drinking cup.

9. Cream and sugar may be added to suit individual taste. The coffee-bean infusion is ready for consumption and enjoyment.

After completion of the brewing process, the filter basket is cleaned. This is accomplished by the following steps:

1. The filter basket is removed from its operating position.

2. The strainer and depleted coffee-bean granules therein are discarded.

3. The displaceable partition is extracted from the main body. This is accomplished (FIGS. 2 and 5) by holding handle 4 with one hand and inserting a finger of the other hand into the main body from the strainer side and from thence through drain hole 6. As it is being inserted, the finger is extended beneath the displaceable partition. Pressure is then exerted on the displaceable partition with the aforesaid finger. As a result of the finger pressure, the main body undergoes a slight flexure, allowing the displaceable partition to be moved past the retaining studs.

4. The displaceable partition is withdrawn from the main body.

5. The main body and the displaceable partition can then be cleaned entirely, thoroughly, easily, and quickly.

Cleaning can be complete, thorough, easy, and quick because of the following novel features of the invention:

1. Drain hole 12 of the main body (FIGS. 8 and 9) is wide enough to allow insertion of a human finger draped with a cleaning cloth. The walls of drain hole 12 can therefore be thoroughly cleaned.

2. The material immediately surrounding drain hole 12 has rounded corners (14, FIG. 9). This facilitates cleaning because pressure from a cleaning cloth can be exerted approximately uniformly across the entire wall of the drain hole. In contrast, if there were 90-degree upper and lower corners to drain hole 12, most of the cleaning pressure would be exerted near the corners with little pressure impinging on most of the wall of the hole; as a result, extra care would have to be taken to thoroughly clean the walls.

3. Interior corner 13 (FIGS. 8 and 9) of the main body is rounded all the way around the main body. As a result, a cleaning cloth can be pressed fully into corner 13, allowing it to be thoroughly and quickly cleaned. In contrast, if corner 13 had a sharp angle a cleaning cloth could not reach fully into the corner.

4. Retaining studs 5 (FIGS. 9 and 10) each have a rounded base corner and a rounded apex. The rounding facilitates fast and thorough cleaning.

5. The upper and bottom corners of the displaceable partition are rounded (8, FIG. 5). This facilitates cleaning because pressure from a cleaning cloth can be exerted approximately uniformly across the entire outer edge and bottom edge of the displaceable partition. In contrast, if the edges had sharp 90-degree corners, most of the cleaning pressure would be exerted near the corners with little pressure impinging on the remainder of the edge; as a result, extra care would have to be taken to thoroughly clean the edges.

6. Interior corner 10 of the displaceable partition (FIG. 5) is rounded around the entire displaceable partition. This allows a cleaning cloth to be pressed fully into corner 10 permitting it to be cleaned completely and quickly. In contrast, if corner 10 had a sharp 90-degree angle a cleaning cloth could not reach fully into the corner.

7. Drain hole 6 of the displaceable partition (FIG. 4) is of a diameter sufficient to allow insertion of a human finger draped with a cleaning cloth. The walls of drain hole 6 can therefore be easily and thoroughly cleaned.

8. The material immediately surrounding drain hole 6 has rounded top and bottom corners (9, FIG. 5). This facilitates cleaning because pressure from a cleaning cloth can be exerted approximately uniformly across the entire wall of the drain hole. In contrast, if there were 90-degree upper and lower corners to drain hole 6, most of the cleaning pressure would be exerted near the corners with little pressure impinging on most of the wall of the hole; as a result, extra care would have to be taken to thoroughly clean the wall.

9. Parallel slots 7 of the displaceable partition are flared in a funnel shape (11, FIG. 6). As a result, a cleaning cloth can be pressed deeply into the wide side of the slots, allowing the walls of the slots to be thoroughly and quickly cleaned.

10. Parallel slots (7, FIG. 4) are used in preference to radial slots because parallel slots, unless near the edge of the displaceable partition, can be longer than radial slots. With longer parallel slots, fewer slots are needed for a given total slot area. As a result, there are fewer slots to clean.

11. The displaceable partition has as few parallel slots as possible consistent with filtering that is rapid enough to prevent overflow of the filter basket. Pressing a cleaning cloth into slots is more time consuming than wiping a flat surface, so a minimal number of parallel slots 7 hastens the cleaning process.

12. The narrow openings of parallel slots 7 (FIG. 6) are as wide as possible consistent with providing sufficient support for the strainer to prevent it from tearing. For a given total area of slot opening, this results in fewer slots, hastening the cleaning process.

13. The strainer is made of high wet-strength paper that has a long-fiber content. This provides resistance to tearing, which allows the narrow openings of parallel slots 7 to be wider than otherwise would be possible. For a give total area of slot opening, this results in fewer slots, hastening the cleaning process.

### DETAILED DESCRIPTION—FIRST ALTERNATIVE EMBODIMENT—FIGS. 11 AND 12

FIG. 11 is a top view of a modified displaceable partition, 17, used in the first alternative embodiment of the invention. FIG. 12 is a partial cross section of displaceable partition 17.

Except as shown in FIGS. 11 and 12, displaceable partition 17 is identical with displaceable partition 3 used in the preferred embodiment (FIGS. 4 and 5).

The first alternative embodiment uses a main body and strainer which are identical with main body 1 and strainer 2 used in the preferred embodiment (FIGS. 1 and 2).

Displaceable partition 17 has a multiplicity of parallel slots, 18. FIG. 12 shows a cross section of one of these slots. The slot is flared in a trumpet shape, 19. The flaring extends around the entire periphery of slot 18, including the ends of the slot. All parallel slots 18 are so flared.

### DETAILED DESCRIPTION—FIRST ALTERNATIVE EMBODIMENT—OPERATION

Coffee brewing with the first alternative embodiment is conducted in the same manner as with the preferred embodiment. However when cleaning is performed, the curved walls, 19, of parallel slots 18 are somewhat difficult to clean because pressure from a cleaning cloth is exerted mainly on a single point of the curve. Therefore several strokes of the cleaning cloth are required to ensure cleanliness.

In contrast, the straight walls of parallel slots 7 in the preferred embodiment receive a more uniform distribution of cleaning pressure. Therefore the slots in the preferred embodiment can be more quickly cleaned.

### DETAILED DESCRIPTION—SECOND ALTERNATIVE EMBODIMENT—FIGS. 13 AND 14

FIG. 13 is a top view of a modified displaceable partition, 20, used in the second alternative embodiment of the invention. FIG. 14 is a partial cross section of displaceable partition 20.

Except as shown in FIGS. 13 and 14, displaceable partition 20 is identical with displaceable partition 3 used in the preferred embodiment (FIGS. 4 and 5).

The second alternative embodiment uses a main body and strainer which are identical with main body 1 and strainer 2 used in the preferred embodiment (FIGS. 1 and 2).

Displaceable partition 20 has a multiplicity of parallel slots, 21. FIG. 14 shows a cross section of one of these slots. The slot is flared in a bowl shape, 22. The flaring extends around the entire periphery of slot 21, including the ends of the slot. All parallel slots 21 are so flared

### DETAILED DESCRIPTION—SECOND ALTERNATIVE EMBODIMENT—OPERATION

Coffee brewing with the second alternative embodiment is conducted in the same manner as with the preferred embodiment. When cleaning is performed, the curved walls, 22, of parallel slots 21 are easily cleaned because pressure from a cleaning cloth can be exerted approximately uniformly across the curved walls of the slots.

However, the material at the narrow openings of slots 21 is thin and subject to breakage. This can be overcome by embodying parallel walls at the narrow opening of the slots, but parallel walls are difficult to clean.

### DETAILED DESCRIPTION—THIRD ALTERNATIVE EMBODIMENT—FIGS. 15 AND 16

FIG. 15 is a top view of a modified displaceable partition, 23, used in the third alternative embodiment of the invention. FIG. 16 is a partial cross section of displaceable partition 23.

Except as shown in FIGS. 15 and 16, displaceable partition 23 is identical with displaceable partition 3 used in the preferred embodiment (FIGS. 4 and 5).

The third alternative embodiment uses a main body and strainer which are identical with main body 1 and strainer 2 used in the preferred embodiment (FIGS. 1 and 2).

Displaceable partition 23 has a multiplicity of parallel slots, 24. FIG. 16 shows a cross section of one of these slots. The top and bottom openings of parallel slot 24 are both flared in a funnel shape, 25. This takes the place of flaring on only one side of the displaceable partition, as in the preferred embodiment (FIG. 6). The top and bottom flaring extends around the entire periphery of slot 24, including the ends of the slot. All parallel slots 24 are so flared.

### DETAILED DESCRIPTION—THIRD ALTERNATIVE EMBODIMENT—OPERATION

Coffee brewing with the third alternative embodiment is conducted in the same manner as with the preferred embodiment. However, when the walls, 25, of parallel slots 24 are cleaned, they must be cleaned from both sides of the displaceable partition. In contrast, the walls of parallel slots 7 in the preferred embodiment can be completely cleaned from one side of the displaceable partition. Therefore the slots in the preferred embodiment can be more quickly cleaned.

### OTHER EMBODIMENTS OF THE INVENTION

The scope of the present invention is not limited to the embodiments described above. Other embodiments are possible while remaining within the scope of the invention. For example:

1. Instead of being shaped as a shallow inverted cup, the displaceable partition can be take the form of a curved bowl, a flat plane, or it can have some other conformation.

2. The main body and displaceable partition can be of material other than plastic.

3. The strainer can be of material other than paper.

4. Instead of retaining studs, other means of holding the displaceable partition in position may be used. These means include, but are not limited to, magnets, clips, friction against the main body, or use of no retaining method and relying on gravity to hold the displaceable partition in place.

5. The flared slots in the displaceable partition need not be parallel.

6. Instead of flared slots in the displaceable partition, there can be one or a plurality of flared apertures that are not shaped as slots.

7. Flared apertures can be in the side of the main body. This can be in addition to, or instead of, flared apertures in the displaceable partition.

8. The displaceable partition can be eliminated, with the main body alone constituting the strainer holder. Flared apertures for infusion drainage can be in the bottom and/or side of the main body.

9. Instead of the material surrounding drain holes having rounded corners, as specified herein for drain hole 6 and drain hole 12, the drain holes can be flared.

10. Instead of parallel slots 7 being flared, as specified herein, they can have rounded edges.

These and other embodiments of the present invention are possible while remaining within the scope of the invention.

Advantages

The invention has the following advantages over prior art:

1. It provides a filter basket that can be cleaned entirely, thoroughly, easily, quickly, and without the use of a harmful chemical.

2. It enhances the marketability of a coffee maker over prior art because:

(a) When the improved filter basket is made of white, light colored, or transparent material, deposits on the filter basket are readily visible and can easily be cleaned off.

(b) In contrast, in prior-art filter baskets made of light colored material, deposits are readily visible but cannot all be easily reached for cleaning. In prior-ait filter baskets made of dark material, deposits are difficult to see as well as difficult to remove entirely.

I claim a filter basket which:

1. Has flared apertures.

2. Is comprised of a strainer holder which has rounding of all angularities that are exposed to coffee infusion.

3. Is comprised of a main body and a displaceable partition, said displaceable partition being movable to provide access for cleaning purposes to the following:
(a) all surface areas of said main body, and
(b) all angularities of said main body, and
(c) all apertures in said main body, and
(d) all surface areas of said displaceable partition, and
(e) all angularities of said displaceable partition, and
(f) all apertures in said displaceable partition.
